(19) United States
(12) Patent Application Publication
(10) Pub. No.: US 2008/0289715 A1
(43) Pub. Date: Nov. 27, 2008

(54) Complex pipe and coating/development processing apparatus equipped with complex pipe

(75) Inventors: Tsunenaga Nakashima, Koshi-shi (JP); Naofumi Kishita, Koshi-shi (JP); Shinichi Hayashi, Koshi-shi (JP)

Correspondence Address: SMITH, GAMBRELL & RUSSELL, 1130 CONNECTICUT AVENUE, N.W., SUITE 1130, WASHINGTON, DC, 20036, US

(73) Assignee: Tokyo Electron Limited

(21) Appl. No.: 11/907,391

(22) Filed: Oct. 11, 2007

(30) Foreign Application Priority Data
Oct. 17, 2006 (JP) 2006-282147

(51) Int. Cl. F16L 9/18; F16L 3/00; B05C 5/00

(52) U.S. Cl. 138/106; 138/112; 118/300

(57) ABSTRACT

In a complex pipe, a plurality of pipe members containing at least a pipe member for liquid and a pipe member for electricity are fixed in parallel arrangement. One end of the complex pipe is connected to a stationary equipment and the other end is connected to a movable member. The plurality of pipe members are integrally combined by a cover member having flexibility. A liquid supply pipe is inserted with a space in the pipe member for liquid. A fluid for temperature adjustment is supplied to the space between the pipe member for liquid and the liquid supply pipe.

### BACKGROUND OF THE INVENTION

1. Field of the Invention

The present invention relates to a complex pipe and a coating/development processing apparatus equipped with a complex pipe.

2. Description of the Related Art

Generally, in manufacture of semiconductor devices, in order to form a thin film or an electrode pattern of ITO (Indium Tin Oxide) on a substrate, such as a semiconductor wafer or an LCD glass substrate, a photo lithography technology is used. According to the photo lithography technology, a series of processes are performed including a process of forming a desired circuit pattern in a resist film by applying a photo resist onto a substrate, exposing the thus-formed resist film in accordance with a predetermined circuit pattern and development-processing the exposure pattern.

Generally, such a process is performed by a coating/development processing apparatus equipped with a plurality of units such as a resist coating process unit, which applies a resist liquid to a substrate and processes the resist liquid, a heat-processing unit, which heats and processes the substrate after the resist coating process or the substrate after the exposure process, a cool-processing unit, which cools the substrate after the heat-processing to a predetermined temperature, and a development-processing unit, which develops and processes the substrate by supplying a development liquid to the substrate.

In the above-mentioned resist coating process unit and development-processing unit of the coating/development processing unit, there are provided nozzles for supplying a resist liquid, a development liquid and a process liquid such as a rinse liquid onto the substrate, and a moving mechanism for moving these nozzles between a substrate surface side and a waiting position on a side of the substrate. Additionally, a plurality of kinds of nozzles are provided so as to supply different kinds of process liquids in accordance with purposes. Thus, in the above-mentioned resist coating unit and development-processing unit, a plurality of pipe members for liquid and pipe members for electric pipes are arranged in a movable state. Ends of the pipes are connected to fixed equipments side, and the other ends are connected to the movable member side, that is, the nozzles and the moving mechanism of the nozzles.

In the apparatus of the above-mentioned structure, there may be a case where the pipes are ground with each other when moving the pipes for processing which results in damage of the pipes. Additionally, there is a problem in that the pipes are damaged by contacting with peripheral equipments due to quaking or bulging caused by vibration of the pipes.

As a means to prevent the above-mentioned damage on the pipes, there is known a structure in which a plurality of pipes are integrally and flatly fixed by, for example, an adhesive or a heat-shrinkable tube (for example, refer to Patent Documents 1 and 2).

Patent Document 1: Japanese Patent Publication No. 2735773 (claims, FIG. 2)

Patent Document 2: Japanese Patent Publication No. 2807627 (claims, FIG. 3)

However, if a pipe member for liquid is used in the piping structure disclosed in the above-mentioned Patent Documents 1 and 2, a pipe length changes due to movement. In such a case, a temperature of the liquid flowing within the pipe member for liquid changes and there is a problem in that it cannot be used as a pipe for a temperature-controlled liquid. Additionally, when fixing a plurality of pipes by an adhesive, a heat-shrinkable tube or the like, a degree of freedom of bending deformation at a fold of the pipe is decreased. Thereby, quaking or bulging is generated in a folded part of the pipe when moving, and there may be generated dusts due to contact with peripheral equipments by the quaking and bulging.

### SUMMARY OF THE INVENTION

It is a general object of the present invention to provide a novel and useful complex pipe and coating/development processing apparatus equipped with the complex pipe, in which the above-mentioned problems are eliminate.

A more specific object of the present invention is to provide a complex pipe and a coating/development processing apparatus equipped with the complex pipe, which suppresses a temperature change due to a change in a length of a pipe when moving and suppresses generation of dusts due to quaking and bulging.

In order to achieve the above-mentioned objects, there is provided according to one aspect of the present invention a complex pipe having a plurality of pipe members containing at least a pipe member for liquid and a pipe member for electricity being fixed in parallel arrangement, one end thereof connected to a stationary equipment and the other end connected to a movable member, wherein the plurality of pipe members are integrally combined by a cover member having flexibility, a liquid supply pipe being inserted with a space in the pipe member for liquid, and a fluid for temperature adjustment is supplied to the space between the pipe member for liquid and the liquid supply pipe.

According to the present invention, since each pipe member is integrally combined by a cover member having flexibility, a degree of freedom can be given to deformation of pipes when moving. Accordingly, generation of dusts due to quaking or bulging of pipes caused by vibration of the pipes can be suppressed. Additionally, since the fluid for temperature adjustment exists in the space between the pipe member for liquid and the liquid supply pipe, the temperature of the liquid flowing in the liquid supply pipe can be adjusted at a constant temperature by the fluid for temperature adjustment. Accordingly, the liquid processing can be stabilized and improvement in processing accuracy can be attempted.

In the above-mentioned invention, although the pipe members may be linear pipe members, they are preferable bellows pipe members having elasticity and flexibility. By constituting as mentioned above, a degree of freedom of deformation can be given to the pipe member itself. Accordingly, generation of dusts due to quaking or bulging of pipes caused by vibration of the pipes can be suppressed further.

Additionally, although the electric wire may be merely inserted into the pipe member for electricity, it is preferable to insert the electric wire into the pipe member for electricity with a space therebetween, and the space between the pipe member for electricity and the electric wire forms an exhaust passage connected to an exhaust apparatus. By constituting as such, particles and mists generated on the movable member side can be discharged to an external part by connecting the exhaust apparatus to the stationary equipment of the pipes. Accordingly, an exhaust function can be given to the pipes without providing a pipe for exhaust separately.

Additionally, it is preferable that a thermal insulation layer is formed between the pipe member for liquid and the cover member covering an entire circumference of the pipe member for liquid. By constituting as such, a liquid flowing in the pipe members, a liquid flowing in the liquid supply pipe and the fluid for temperature adjustment can be prevented from being influenced by an ambient temperature of outside. Accordingly, the liquid processing can be stabilized further, and improvement in the processing accuracy can be attempted.

Additionally, a plate spring member may be provided along an arranging direction of the pipe members in the cover member. By constituting as such, quaking and bulging generated in a folded part of the pipes when moving the pipes due to vibration of the pipes can be suppressed. Accordingly, generation of dusts when moving the pipes can be suppressed further.

Additionally, a base member on which the cover member is movably placed may be provided, and a concave line and a convex line engaging with each other may be formed on opposing contact surfaces of the base member and the cover member. By constituting as such, the concave line and the convex line provided on the opposing contact surfaces of the cover member and the base member when moving the pipes slide to each other, which can suppress quaking of left and right of the pipes, and the movement of the pipes can be made smooth. Accordingly, generation of dusts when moving the pipes can be suppressed further.

In addition, in the pipe member for liquid, it is preferable that a volume enlargement part of a liquid flowing in the pipe members is provided to an end part of the pipe member for liquid. By constituting as such, a volume change of the liquid flowing in the liquid supply pipe in association with a change in a length due to a movement of the pipes can be variably adjusted by the volume enlargement part. Accordingly, the liquid processing can be stabilized further, and improvement in the processing accuracy can be attempted.

Additionally, there is provided according to another aspect of the present invention a coating/development processing apparatus comprising: the above-mentioned complex pipe; a coating process part that applies a process by supplying a coating liquid to a substrate to be processed; and a development process part that applies a process by supplying a developer liquid to the substrate to be processed, wherein the coating process part and the development process part are equipped with a liquid supply nozzle and a moving mechanism of the liquid supply nozzle, and the movable member of the complex pipe is connected to the liquid supply nozzle and the moving mechanism.

According to the above-mentioned invention, a degree of freedom can be given to deformation of the pipes during movement when processing in the coating process part and the development process part. Accordingly, generation of dusts due to quaking or bulging of pipes caused by vibration of the pipes can be suppressed. Additionally, since the fluid for temperature adjustment exists in the space between the pipe member for liquid and the liquid supply pipe, the temperature of the liquid flowing in the liquid supply pipe can be adjusted at a constant temperature by the fluid for temperature adjustment. Accordingly, the process in the coating/development processing can be stabilized and improvement in processing accuracy can be attempted.

### BRIEF DESCRIPTION OF THE DRAWINGS

FIG. 1 is an outline plan view showing an example of a resist coating/development processing apparatus equipped with a complex pipe according to the present invention;

FIG. 2 is an outline perspective view of the resist coating/development processing apparatus shown in FIG. 1;

FIG. 3 is an outline side cross-sectional view of the above-mentioned resist coating/development processing apparatus;

FIG. 4 is an outline perspective view showing a unit block (DEV layer) of a process block in the present invention;

FIG. 5 is an outline cross-sectional view showing an example of a process unit of the process block in the present invention;

FIG. 6 is an outline plan view showing a unit block (COT layer) of the process block in the present invention;

FIG. 7 is a plan view of the unit block (COT layer);

FIG. 8 is an outline cross-sectional view of a coating process part of the unit block (COT layer);

FIG. 9 is an outline perspective view showing a connection state of the complex pipe according to the present invention in the coating process part;

FIG. 10A is a cross-sectional view of the complex pipe;

FIG. 10B is a cross-sectional view taken along a line I-I of FIG. 10A;

FIG. 11 is a perspective view showing a folded part of the complex pipe;

FIG. 12 is a cross-sectional view showing the complex pipe in a development process part of the unit block (DEV layer);

FIGS. 13A and 13B are outline cross-sectional views showing an example of the process unit of the process block in the present invention;

FIG. 14A is a perspective view showing a part of another complex pipe;

FIG. 14B is a cross-sectional view taken along a line II-II of FIG. 14A;

FIG. 15A is a perspective view showing a part of a further complex pipe;

FIG. 15B is a cross-sectional view taken along a line III-III of FIG. 15A; and

FIG. 16 is an outline side view showing a complex pipe equipped with a volume enlargement part (buffer part).

### DETAILED DESCRIPTION OF THE PREFERRED EMBODIMENT

A description will be given below, with reference to the drawings, of embodiments according to the present invention. In the embodiments explained below, a complex pipe according to the present invention is applied to a resist coating/development processing apparatus of a semiconductor wafer.

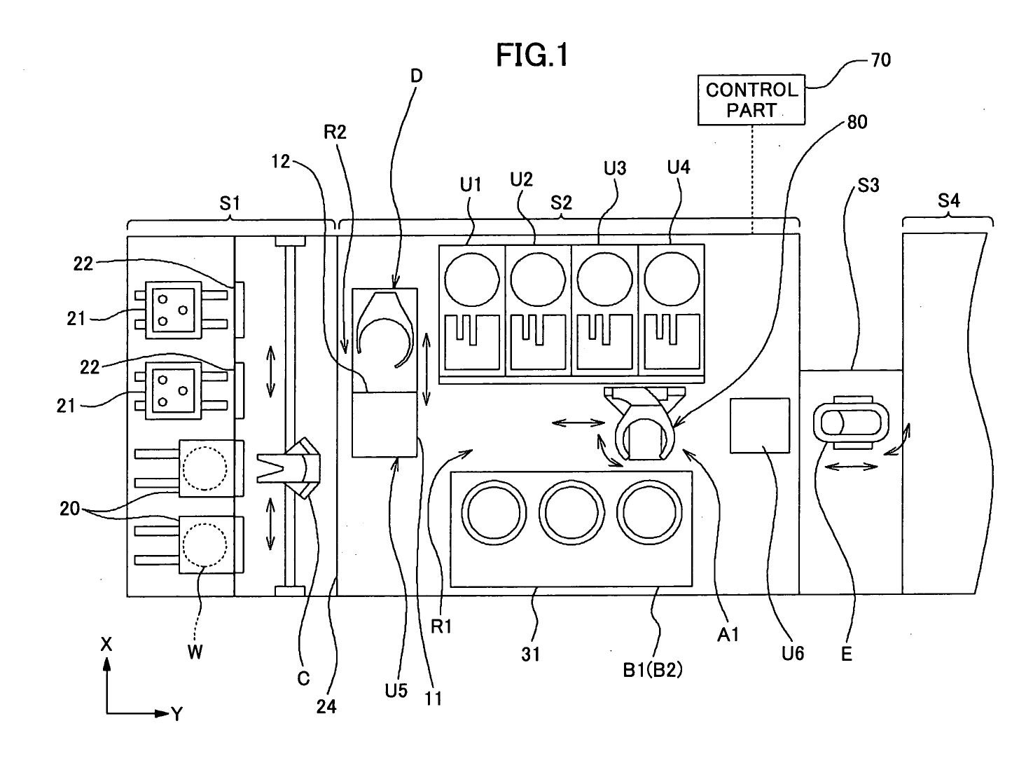

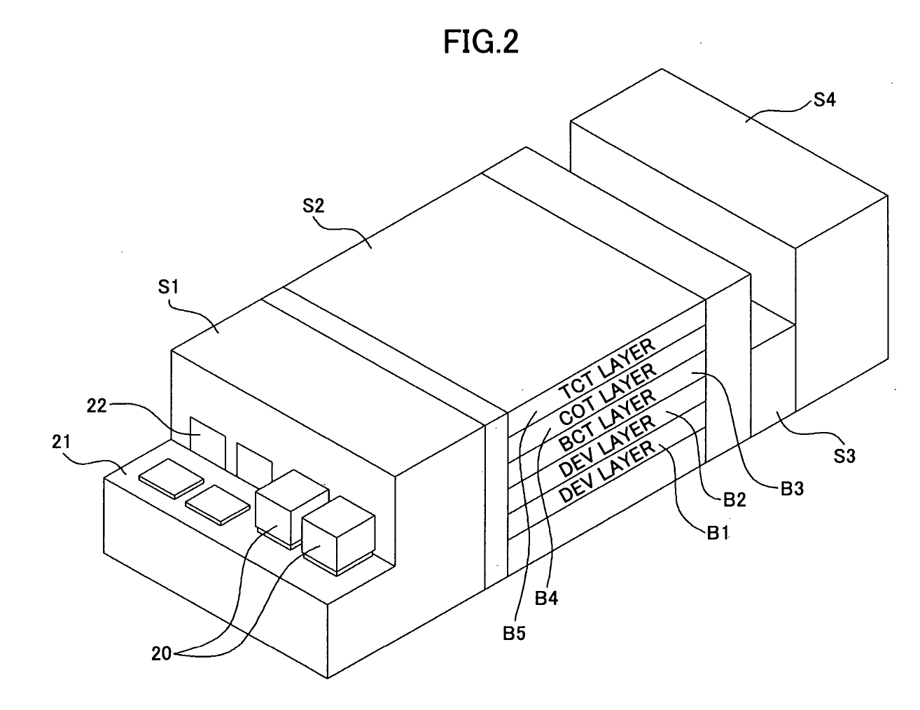

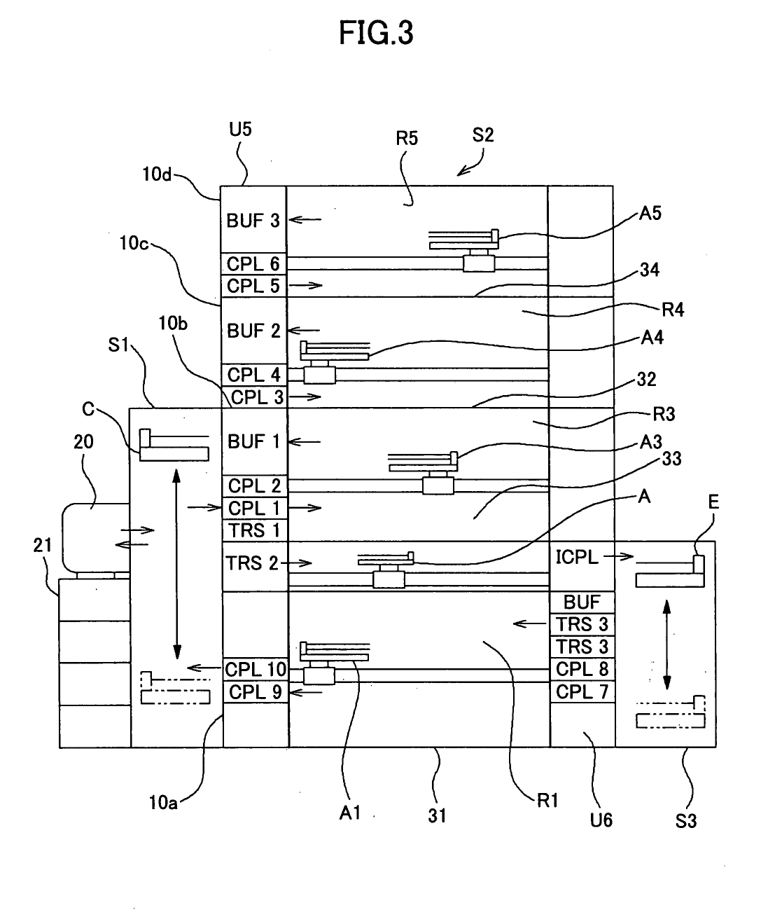

FIG. 1 is an outline plan view showing an example of a resist coating/development processing apparatus. FIG. 2 is an outline perspective view of the resist coating/development processing apparatus. FIG. 3 is an outline side view of the resist coating/development processing apparatus.

The resist coating/development processing apparatus comprises a carrier block S1 for conveying in and out a carrier 20 in which, for example, twenty-five sheets of semiconductor wafer W (hereinafter, referred to as wafer W), which is a substrate, are accommodated, a process block S2 constituted by arranging, for example, five unit blocks B1 to B5, an interface block S3 and an exposure apparatus S4.

The carrier block S1 is provided with a placement table 21 on which a plurality of carriers 20 (for example, four pieces) can be placed, an opening and closing part 22 provided on a front wall surface viewed from the placement table 21, and a transfer arm C for taking out the wafers W from the carrier through the opening and closing part 22. The transfer arm C is constituted to be movable in X, Y directions and a vertical Z direction and rotatable about a vertical axis so that transfer of the wafers W can be carried out between transfer stages TRS1 and TRS2 provided in a shelf unit U5 constituting a substrate accommodation part.

A process block S2 surrounded by a housing 24 is connected to a back side of the carrier block S1. In this example, two lowermost stages in the process block S2 are assigned as first and second blocks (DEV layer) B1, B2 for performing a development process. A third stage from the bottom is assigned as a third unit block (BCT layer) B3 which is a unit block for forming a reflection-preventing film (hereinafter, referred to as “first reflection-preventing film”) on a lower layer side of the resist film. A fourth stage from the bottom is assigned as a fourth unit block (COT layer) B4, which is a unit block for forming a coating film to perform a coating process of a resist liquid. Additionally, a fifth stage from the bottom, that is, the uppermost stage is assigned as a fifth unit block (TCT layer) B5, which is a unit block for forming a second reflection-preventing film to perform a forming process of a reflection-preventing film (hereinafter, referred to as “second reflection-preventing film”) on an upper layer side of the resist film. The DEV layers B1 and B2 correspond to the unit blocks for development process, and the BCT layer B3, the COT layer B4 and the TCT layer B5 correspond to the unit blocks for forming a coating film.

The first to fifth unit blocks B1 to B5 comprise a liquid process unit for applying a liquid to a wafer W, a process unit provided on a back side, such as various heating units for performing a preprocess and a post process performed in the above-mentioned liquid process unit, and main arms A1, A3 to A5 which are an exclusive substrate conveyance means for exchanging the wafer W between the above-mentioned liquid process unit provided on the front side and the process unit such as a heating unit provided on the back side.

In this example, the unit blocks B1 to B5 are set up so that the liquid process unit, the process units such as a heating unit, and the conveyance means are in the same arrangement layout in each of the unit blocks B1 to B5. Here, the same arrangement layout means that a center of placement of the wafer W, that is, a center of a spin chuck which is a support means of the wafer W in the liquid process unit, and centers of a heating plate and a cooling plate in the heating unit are at the same positions, respectively.

As shown in FIG. 1, the DEV layers B1, B2 are constituted similarly, and are formed in common in this case. A conveyance area R1 (a horizontally moving area of the main arm A1) of the wafer W for connecting the carrier block S1 and the interface block S3 in a direction of a length of the DEV layers B1, B2 (Y direction in the figure) is formed at a generally center of the DEV layers B1, B2.

A development unit 31 which is equipped with a plurality of development process parts for performing a development process is provided on the right side when viewing from the near side (carrier block S1 side) to the far side on both sides when viewed from the carrier block S1 side of the conveyance area R1. Each unit block is provided with, for example, four shelf units U1, U2, U3, U4, which are multi-stage heating system unit on the left side when viewing from the near side to the far side. In this figure, various units for performing a preprocess and a post process of the process performed by the development unit 31 are arranged in a plurality of stacked layers, for example, three stages. As mentioned above, the development unit 31 and the shelf units U1 to U4 are defined by the above-mentioned conveyance area R1. By injecting clean air into the conveyance area R1 and discharging therefrom, floatation of particles in the area is prevented.

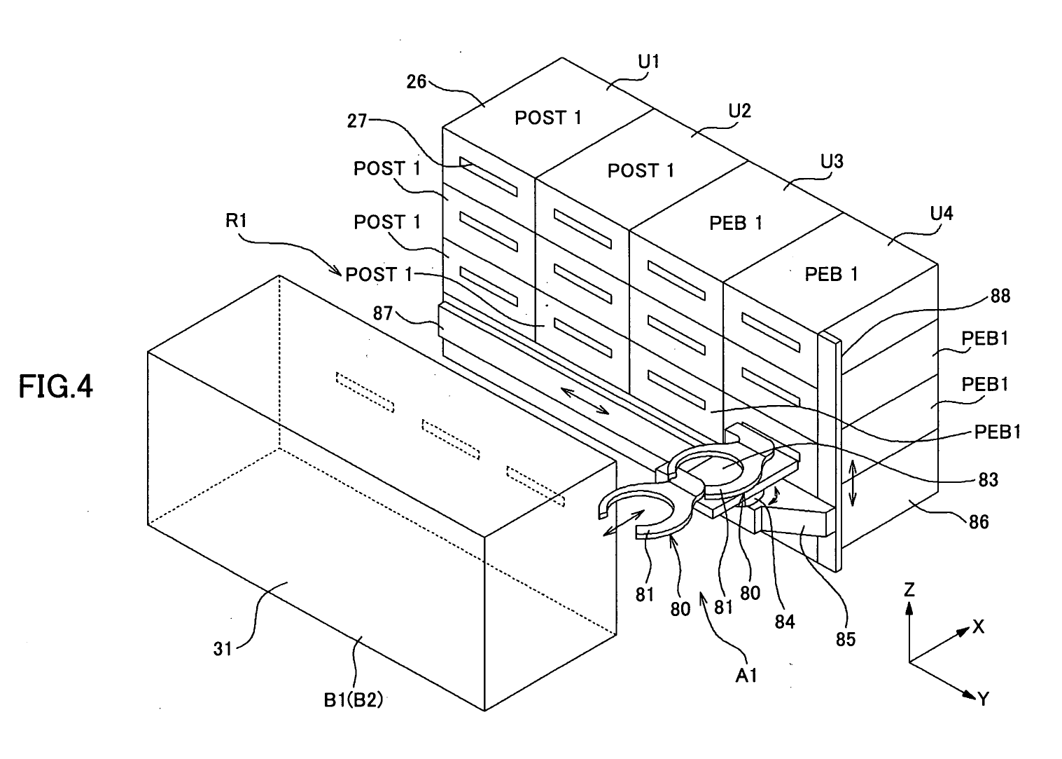

The above-mentioned various units for performing a preprocess and a post process include, such as shown in FIG. 4, a heating unit (PFB1), referred to as a post exposure baking unit, for heating the wafer W after exposure, and a heating unit (POST1), referred to as a post baking unit, for heating the wafer W after development process to remove a water component. The process units such as the heating units (PEB1, POST1) are accommodated in process containers 26, respectively. The shelf units U1 to U4 are constituted by stacking the process chambers 26 in three stages each, and a wafer carry out and in port 27 is formed on a surface of each process container 26 facing the conveyance area R1.

The above-mentioned main arm A1 is provided in the conveyance area R1. The main arm A1 is constituted so that transfer of a wafer can be performed between all modules (locations at which the wafer W is placed) within the DEV layer B1, such as, for example, each process unit of the shelf units U1 to U4, the development unit 31 and the shelf unit U5. Accordingly, the main arm A1 is movable in the horizontal X, Y directions and the vertical Z direction, and also rotatable about the vertical axis.

It should be noted that the main arms A1 and A3-A5 have the same structure, and a description will be given of the main arm A1 as a representative. The main arm A is equipped with an arm body 80 having two curved arm strips 81 for supporting circumferential areas of a backside of the wafer W. The curved arm strips 81 are constituted so as to be movable forward and rearward along a base table 83 independently from each other. The base table 83 is constituted so as to rotatable about the vertical axis by a rotating mechanism 84. The base table is also movable in the Y direction along a Y-axis rail 87 attached to a surface of the base table 86 supporting the shelf units U1 to U4 facing the conveyance area R1, and movable upward and downward along a lift rail 88. As mentioned above, the curved arm strips 81 are constituted so as to be movable forward and rearward in the X direction, movable in the Y direction, and rotatable about the vertical axis so that curved arm strips 81 can transfer the wafer W between each unit of the shelf units U1 to U4 and the liquid process unit. Operations of the main arm A1 is controlled by a controller (not shown in the figure) based on an instruction from a control part 70. Additionally, in order to prevent heat accumulation of the main arm A1 (A3 to A5) in the heating unit, a reception sequence of the wafer W can be controlled arbitrarily according to a program.

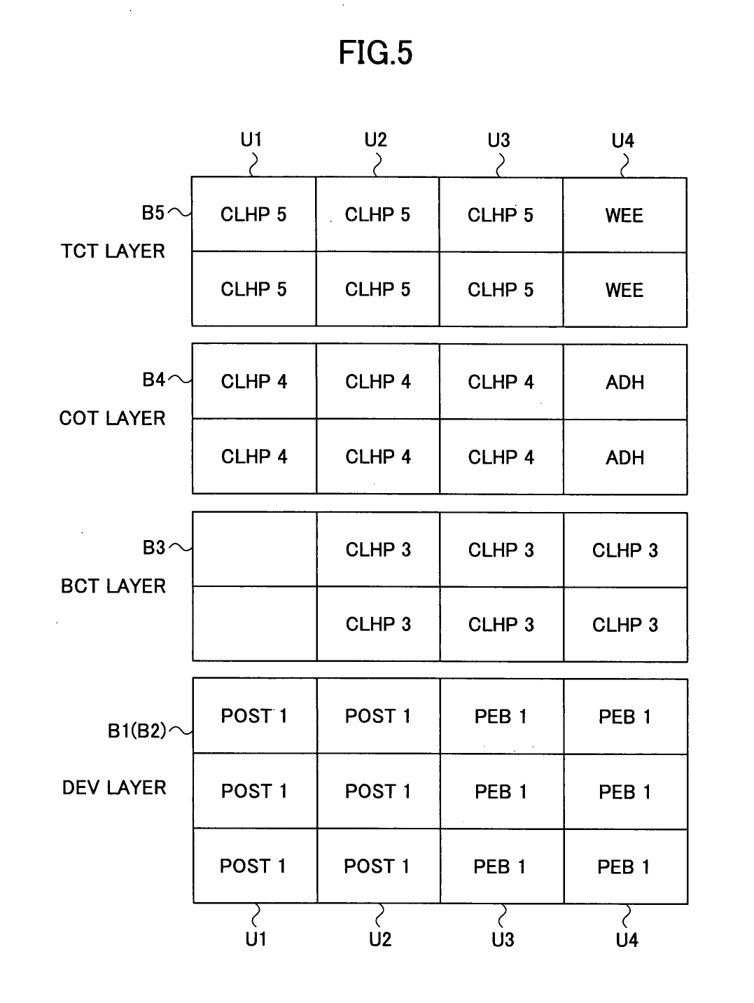

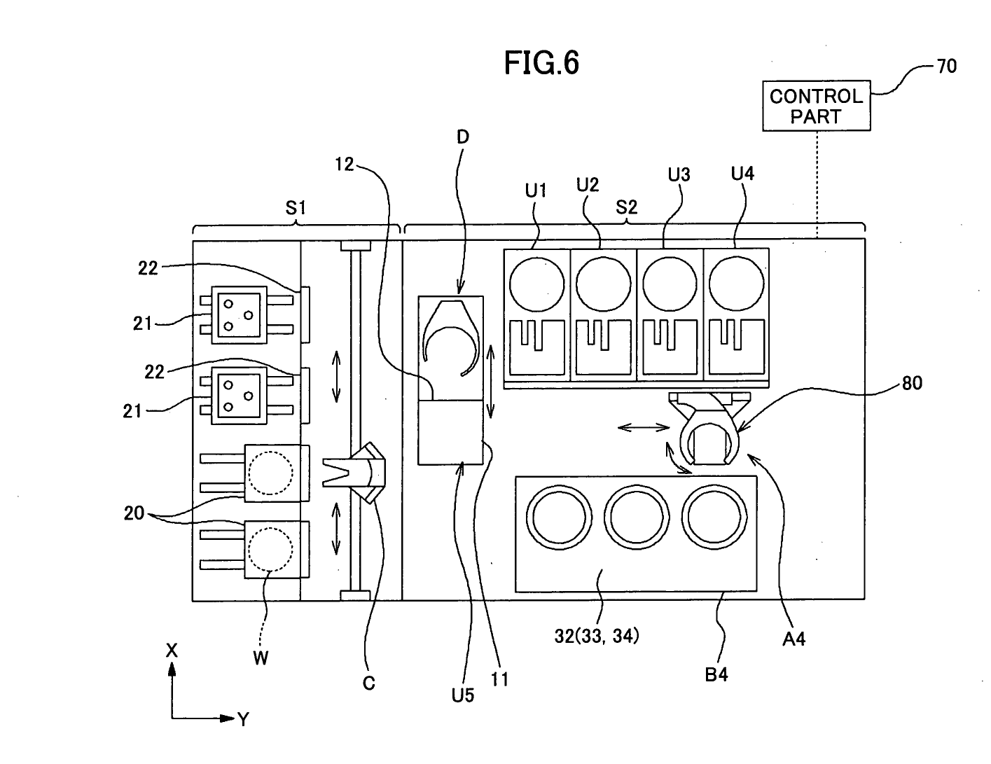

Moreover, the unit blocks B3 to B5 for coating film formation have the same structure as the above mentioned unit blocks B1, B2 for development process. A description will be given, with reference to FIG. 3, FIG. 5 and FIG. 6, of the COT layer B4 as an example. A coating unit 32 is provided as a liquid process unit to perform a coating process of a resist liquid to the wafer W. The shelf units U1 to U4 of the COT layer B4 are provided with a heating unit (CLHP4) for heating the wafer W after coating of the resist liquid, and a hydrophobic process unit (ADH) to improve adhesion between the resist liquid and the wafer W, and is configured similar to the DEV layers B1, B2. That is, it is constituted so that the coating unit 32 and the heating unit (CLHP4) and the hydrophobic process unit (ADH) are separated by a conveyance area R4 of the main arm A4 (horizontally moving area of the main arm A4). Then, in the COT layer B4, transfer of the wafer W is performed by the main arm 4 with the cooling plates CPL3, CPL4 of the shelf unit U5, the coating unit 32 and each process unit of the shelf unit U1 to U4. It should be noted that the hydrophobic process unit (ADH) performs a gas process in an HMDS atmosphere, and may be provided one of the unit blocks B3 to B5 for coating film formation.

The BCT layer B3 is provided with a first reflection-preventing film formation unit 33 as a liquid process unit for performing a formation process of the first reflection-preventing film to the wafer W. The shelf units U1 to U4 are provided with a heating unit (CLHP3) which heat-treats the wafer W after the reflection-preventing film formation process, and is configured to be the same structure as the COT layer B4. That is, the first reflection-preventing film formation unit 33 and the heating unit (CLHP3) are configured to be defined by a conveyance area R3 of the main arm A3 (horizontal moving area of the main arm A3). Then, in the unit block B3, transfer of the wafer W can be performed by the main arm A3 with a delivery stage TRS1 of the shelf unit U5, the cooling plates CPL1 and CPL2, the first reflection-preventing film formation unit 33 and each process unit of the shelf units U1 to U4.

The TCT layer B5 is provided with a second reflection-preventing film formation unit 34 as a liquid process unit for performing a formation process of the second reflection-preventing film to the wafer W. The shelf units U1 to U4 is configured to be the same structure as the COT layer B4 except that a heating unit (CLPH5) for heating the wafer W after the reflection-preventing film formation process and a peripheral exposure equipment (WEE) are provided. That is, the second reflection-preventing film formation unit 34, the heating unit (CLHP5) and the peripheral exposure equipment (WEE) are configured to be defined by a conveyance area R5 of the main arm A5 (horizontal moving area of the main arm A5). Then, in the unit block B5, transfer of the wafer W can be performed by the main arm A5 with the cooling plates CPL5 and CPL6 of the shelf unit U5, the second reflection-preventing film formation unit 34 and each process unit of the shelf units U1 to U4.

In the process block S2, a shuttle arm A is movably arranged in the horizontal Y direction and movably arranged upward and downward in the vertical Z direction. The shuttle arm A is a substrate conveyance means for exchanging the wafer A between the transfer stage TRS2 provided in the shelf unit U5 and the shelf unit U6 on the interface block S3 side.

It should be noted that the conveyance area of the shuttle arm A and the conveyance areas R1, R3 to R5 of the above-mentioned main arm A1, A3 to A5 are defined respectively.

Moreover, an area between the process block S2 and the carrier block S1 is a transfer area R2 of wafer W. In the transfer area R2, as shown in FIG. 1, the shelf unit U5, which is a substrate accommodating part, is provided at a location where the transfer arm C, the main arms A1, A3 to A5 and the shuttle arm A are accessible. Additionally, there is provided an arm D which constitutes a substrate transfer means for transferring the wafer to the shelf unit U5. The shelf unit U5 is located on an axis line of the horizontal moving direction (Y direction) of the main arms A1, A3 to A5 and the shuttle arm A, and a first opening part 11 is provided in the direction of forward and rearward movement of the shuttle arm A (Y direction), and a second opening part is provided in the direction of forward and rearward movement of the transfer arm D (X direction).

It should be noted that two-stage cooling plates CPL 9, CPL 10 are arranged in a first accommodation block 10a which is a lowermost stage among accommodation blocks 10a to 10d of the shelf unit U5. Two-stage cooling plates CPL1, CPL2 and a plurality of placement shelves BUF1 are arranged in the second accommodation block 10b. Two-stage cooling plates CPL3, CPL4 and a plurality of placement shelves BUF2 are arranged in the third accommodation block 10c. Two-stage cooling plates CPL5, CPL6 and a plurality of placement shelves BUF3 are arranged in the fourth accommodation block 10d which is an uppermost stage.

Moreover, as shown in FIG. 1 and FIG. 3, in an area adjacent to the above-mentioned process block S2 and the interface block S3, the shelf unit U6 is provided at a position where the main arm A1 and the shuttle arm A is accessible. The shelf unit U6 is equipped with, as shown in FIG. 3, two transfer stages TRS 3 and a transfer stage ICPL having a cooling function and performing transfer of the wafer W with the shuttle arm A, so that transfer of the wafer W is performed between the main arms A1 of the DEV layers B1, B2.

It should be noted that FIG. 5 shows an example of the layout of the process units, and this layout is shown for an expediential purpose. The process units are not limited to the heating units (CLHP, PEB, POST), the hydrophobic process apparatus (ADH) and the peripheral exposure equipment (WEE), and other process units may be provided. Additionally, in an actual apparatus, a number of units installed may be determined in consideration of a process time of each process unit.

On the other hand, on the back side of the shelf unit U6 in the process block S2, an exposure apparatus S4 is connected via the interface block S3. An interface arm E is provided to the interface block S3 to transfer the wafer W to each part of the shelf unit U6 of the DEV layers B1, B2 of the process block S2 and the exposure apparatus S4. The interface arm E forms a conveyance means of the wafer W, which lies between the process block S2 and the exposure apparatus S4. In this example, the interface arm E is movable in the horizontal X, Y directions and vertical Z direction and rotatable about the vertical axis.

In the resist coating/development processing apparatus of the above-mentioned structure, transfer of the wafer W can be made freely between the unit blocks B1 to B5 that are stacked in five stages by the transfer arm D via the transfer stages TRS1, TRS2. Additionally, transfer of the wafer W can be carried out between the process block S2 and the exposure device S4 by the above-mentioned interface arm E via the unit blocks B1, B2 for development process.

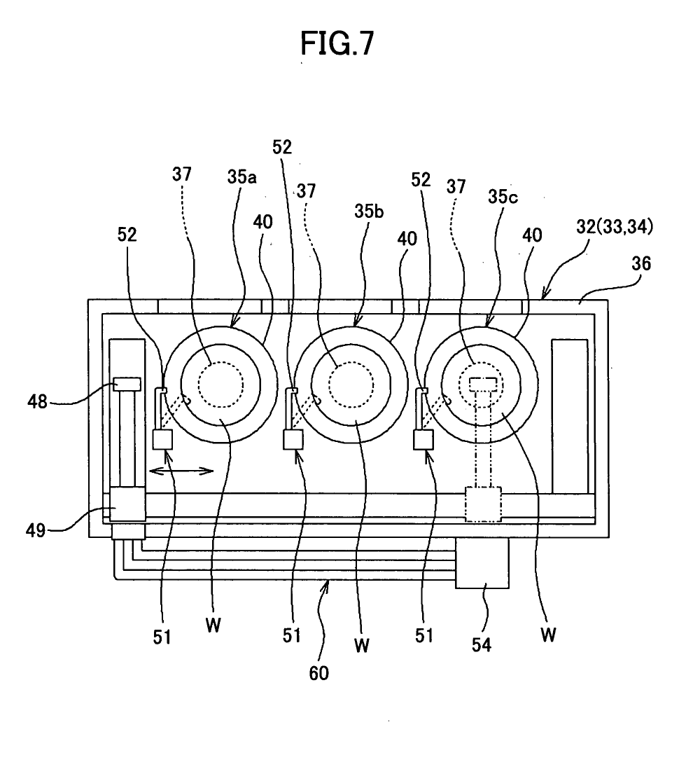

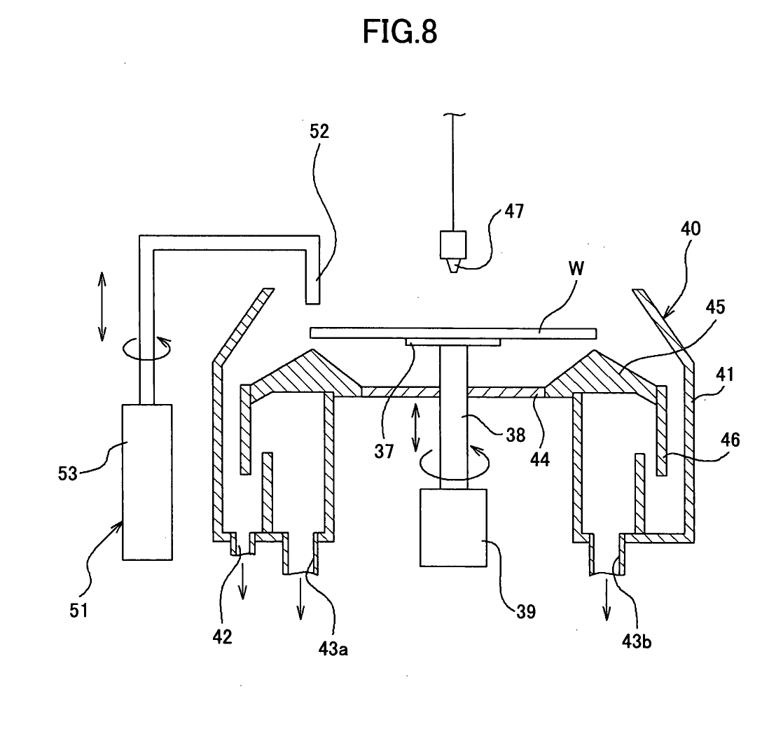

A description will be given of a process part equipped with a complex pipe according to the present invention, such as, for example, the coating unit 32, the first reflection-preventing film formation unit 33, and the second reflection-preventing film formation unit 34. Since the coating unit 32, the first reflection-preventing film formation unit 33, and the second reflection-preventing film formation unit 34 have the same structure, a description will be given, with reference to FIG. 7 and FIG. 8, of the coating unit 32 as a representative.

In the coating unit 32, there is provided three liquid process parts 35, in this example, on the common housing 36 in a state where they are arranged in a transverse direction (Y direction). The liquid process part 35a, 35b and 35c (hereinafter represented by a reference numeral 35) is equipped with a spin chuck 37 which is a substrate support part for supporting the wafer W horizontally by suctioning a central portion of the backside of the wafer W. The spin chuck 37 is connected to a drive mechanism (spin chuck motor) 39 via a shaft part 38, and configured to be rotatable and movable upward and downward.

On the outside of the circumference of the wafer W supported by the spin chuck 37, a cup member 40 opening at an upper side is provided so as to surround the wafer W. The upper end of the side circumference surface of the cup member 40 is inclined inwardly. On the bottom side of the cup member 40, a liquid reception part 41 forming a concave form is defined as an outer area and an inner area over an entire circumference under the circumferential edge of the wafer W. A liquid discharge port 42 for discharging drains such as stored coating liquid is provided in the bottom part of the outer area. Two exhaust ports 43a, 43b are provided in the bottom part of the inner area. Additionally, a circular plate 44 is provided under the wafer W, and a ring member 45 is provided to surround the outer side of the circular plate 44. Further, a downward cylindrical member 46 extending downward is provided on an outer end surface of the ring member 45 so as to enter the outer area. It is configured so that the coating liquid is guided to the outer area by moving surfaces of the downward cylindrical part 46 and the ring member 45. It should be noted that, although illustration is omitted, a lifter pin, which is movable upward and downward while supporting the backside of the wafer W, is provided by vertically extending through the circular plate 44. It is configure so that transfer of the wafer W to the spin chuck 37 can be carried out according to a cooperation action of the lifer pin and the main arm A4.

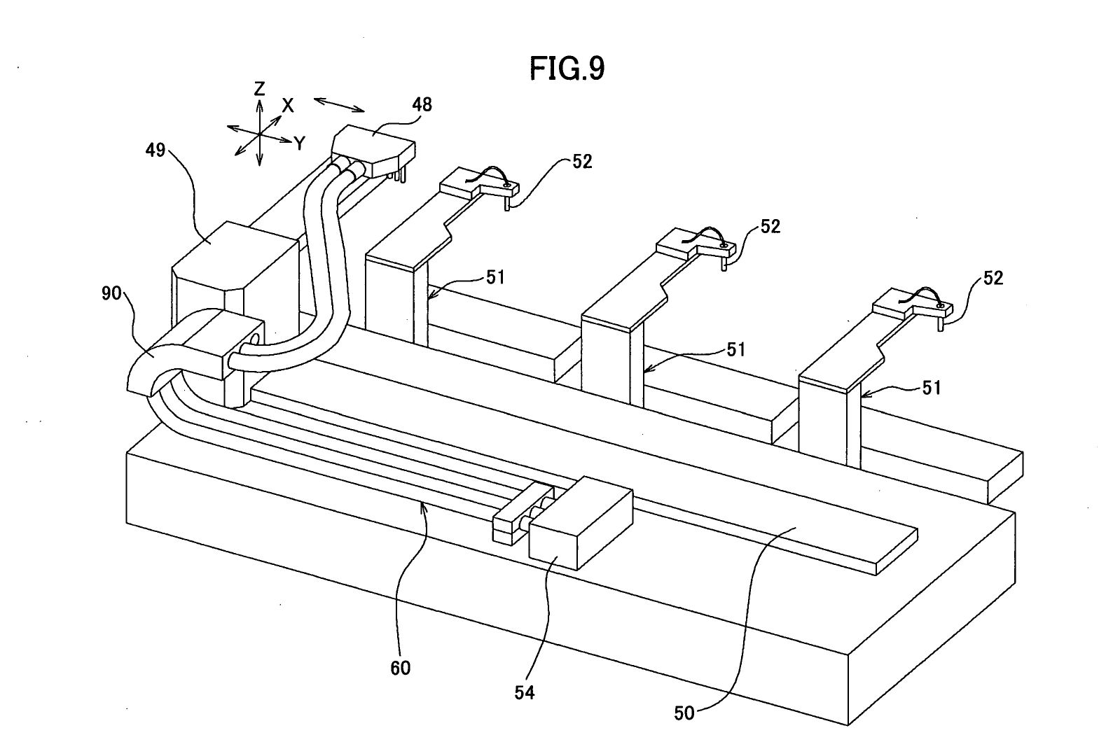

Moreover, as shown in FIG. 9, the coating unit 32 is provided with a nozzle head 48 and a nozzle drive mechanism 49 of the nozzle head 48, the nozzle head 48 having a plurality of supply nozzles 47 for supplying a chemical liquid to the three liquid process parts 35a, 35b and 35c. The nozzle drive mechanism 49 is configured to move the nozzle head 48 upward and downward in the vertical direction (Z direction) and in the Y direction by the guide rail 50 provided along the direction of a length of the coating unit (Y direction).

Moreover, a side rinse mechanism 51 is provided at a position near the outer side of the cup member 40 in each liquid process part 35a, 35b, 35c. The side rinse mechanism 51 is configured by a rinse nozzle 52, which is bent in an L-letter shape and a drive part 53 which drives the rinse nozzle 52 movably upward and downward and rotatably.

An end of the complex pipe 60 according to the present invention is connected to the nozzle head 48 and the nozzle drive mechanism 49 in the coating unit 32 having the above-mentioned structure. The complex pipe 60 is arranged along the side of the housing 36, and the other end is connected to a pipe coupling block 54 on the stationary equipment side.

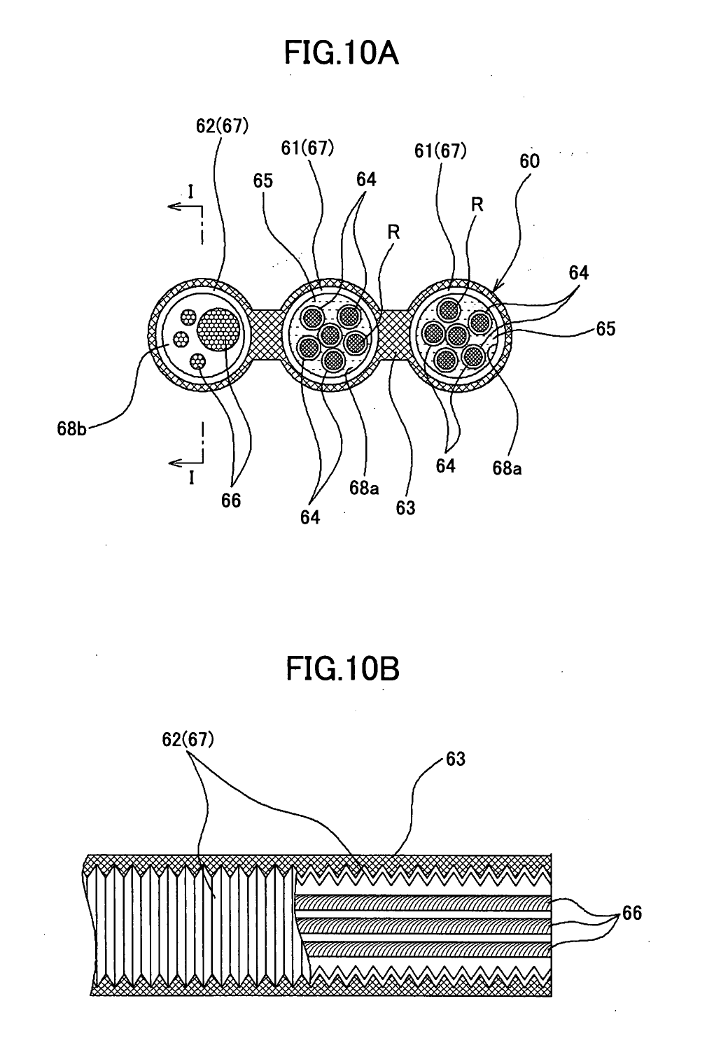

As shown in FIG. 10A, the complex pipe 60 includes two pipe members 61 for liquid connected to the nozzle head 48 and one pipe member 62 for electricity connected to the nozzle drive mechanism 49, which are integrally combined by a cover member 63 made of, for example, a synthetic rubber having flexibility in a parallel state. Six liquid supply pipes 64 are inserted into each of the two pipe members 61 for liquid with a space therebetween, and a fluid 65 for temperature adjustment is provided (flow) in the space part 68a between each pipe member 61 for liquid and the liquid supply pipes 64. In this case, as for the fluid 65 for temperature adjustment, a temperature-controlled water or the like may be used of which temperature is adjusted at a predetermined temperature by a temperature adjusting mechanism (not show in the figure). It should be noted that a resist liquid R as a coating liquid flows in eleven liquid supply pipes 64 from among the twelve liquid supply pipes 64. A thinner which is a solvent of the resist flows in the rest of the one liquid supply pipe 64. As mentioned above, by providing the fluid 65 for temperature adjustment in the space part 68a between each pipe member 61 for liquid and liquid supply pipes 64, the resist liquid and the thinner used for the process can be adjusted to a predetermined temperature.

Moreover, a plurality of electric wires 66 (four lines in the figure) are inserted into the pipe member 62 for electricity with a space therebetween, and a space part 68b between the pipe member 62 for electricity and the electric wires 66 forms an exhaust passage connectable to an exhaust means (not shown in the figure). As mentioned above, by making the space part 68b as an exhaust passage between the pipe member 62 for electricity and electric wires 66 and connecting to the exhaust means, dusts, particles and mists generated on the process part side during the process can be exhausted outside the apparatus.

It should be noted that each pipe member 61, 62 may be formed by a linear pipe member if it has flexibility, but it is preferable to be formed by, for example, a bellows-like pipe member 67 made of a synthetic resin having elasticity and flexibility. By forming the pipe members 61, 62 by a bellows-like pipe member 67 having elasticity and flexibility, a degree of freedom of bending deformation can be given to the pipe during movement of the pipe. Thus, according to the synergy effect of the cover member 63 having flexibility and the bellows-like pipe member 67 having elasticity and flexibility, quaking or vibration and bulging of a folded part of the complex pipe 60 during movement of the pipe can be suppressed.

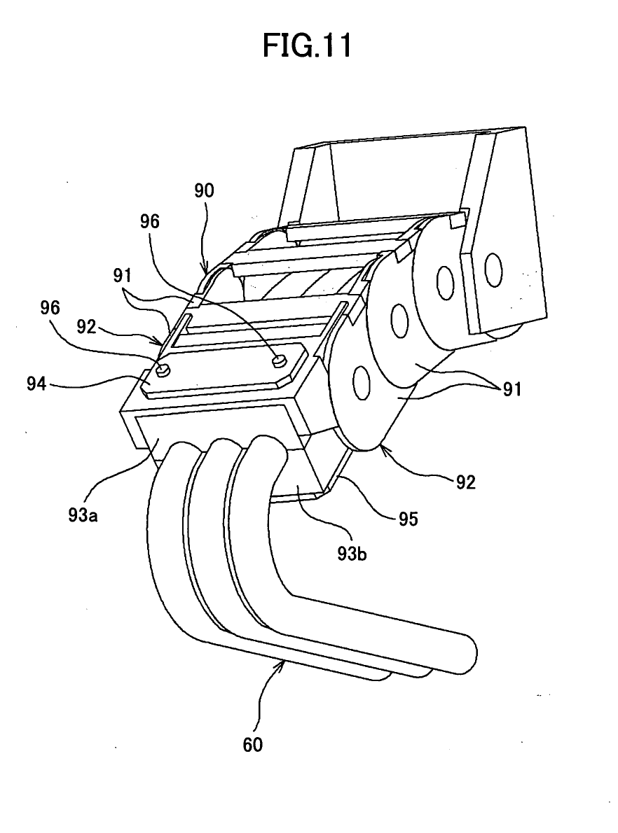

It should be noted that a cable bear 90 is attached to an end side of the complex pipe 60, that is, a position near the part connected to the nozzle head 48 and the nozzle drive mechanism 49 so as to improve a degree of freedom of the complex pipe 60 which deforms depending on a waiting state and a processing state of the supply nozzle 47 and limit an upward and downward movement. The cable bear 90 is equipped with, as shown in FIG. 11, a pair of opposing side frames 92 formed by a plurality of link plates 91 connected rotatably in one direction, and upper and lower support members 93a, 93b made of a synthetic rubber and divided into two pieces so as to movably support the three pipe members 61, 61, 62. The side frames 92 and plate members 94, 95 provided upper and lower parts of the support members 93a, 93b are fixed by coupling screws 96. It should be noted that a protective plates (not shown in the figure) made of, for example fluorocarbon resin are attached to the upper and lower parts of the pipe members 61, 61, 62 so as to prevent the pipe members 61, 61, 62 from sliding on the cable bear 90.

By attaching the cable bear 90 of the above-mentioned structure to the folded part of the complex pipe 60, vibration of the folded part in the vertical direction during movement of the pipe can be suppressed and bulging of the folded part can be suppressed.

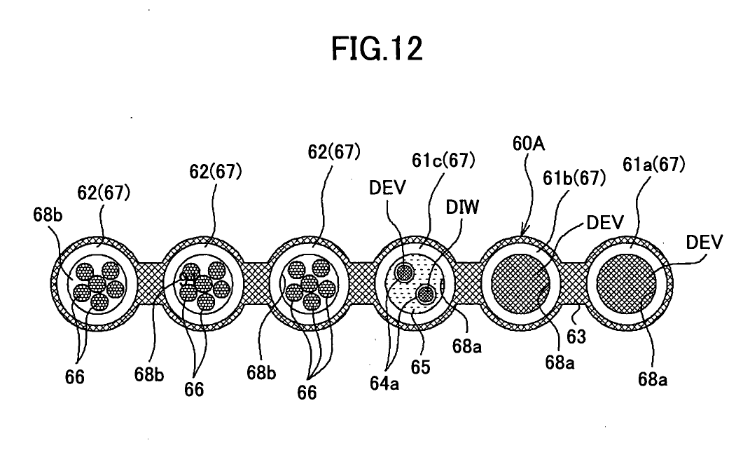

Although the case where the complex pipe 60 according to the present invention is used in the coating unit 32 in the above explanation, the complex pipe 60 can be used in the development unit 31 in the similar manner. That is, a complex pipe 60A can be used, one end thereof is connected to a nozzle block having a supply nozzle and a supply nozzle moving mechanism of the supply nozzle in the development unit 31, and the other end is connected to a stationary equipment side, the supply nozzle for liquids in a plurality of liquid process parts (for example, three liquid process parts) such as a development liquid and a rinse liquid. In this case, the complex pipe 60A includes, as shown in FIG. 12, three pipe members 61a, 61b, 61c for liquid connected to the nozzle block and three pipe members 62 for electricity connected to the nozzle drive mechanism, which are integrally combined by a cover member 63 made of, for example, a synthetic rubber having flexibility in a parallel state. The two pipe members 61a, 61b for liquid out of three pipe members are capable of causing, for example, a development liquid DEV to flow therethrough. Two liquid supply pipes 64a are inserted into the rest of one pipe member 61c with a space therebetween, the liquid supply pipes 64a are capable of causing, for example, the development liquid DEV and a rinse liquid DIW to flow therethrough. A fluid 65 for temperature adjustment is provided in a space part 68a between the pipe member 61c for liquid and the liquid supply pipe 64a. By causing the fluid 65 for temperature adjustment to flow in the space part 68a between the pipe member 61c for liquid and the liquid supply pipe 64a, the development liquid DEV and the rinse liquid DIW used in the process can be adjusted at a predetermine temperature.

Additionally, a plurality of electric wires 66 are inserted into the three pipe members 62 for electricity (five lines are indicated in the figure). A space part 68b between the pipe member 62 for electricity and the electric wires 66 forms an exhaust passage connectable to an exhaust means (not shown in the figure). As mentioned above, by making the space part 68b as an exhaust passage between the pipe member 62 for electricity and electric wires 66 and connecting to the exhaust means, dusts, particles and mists generated on the process part side during the process can be exhausted outside the apparatus.

It should be noted that other parts in the complex pipe 60A used in the development unit 31 are formed the same as the complex pipe 60 used in the coating unit 32, and the same parts are given the same reference numerals and descriptions thereof will be omitted.

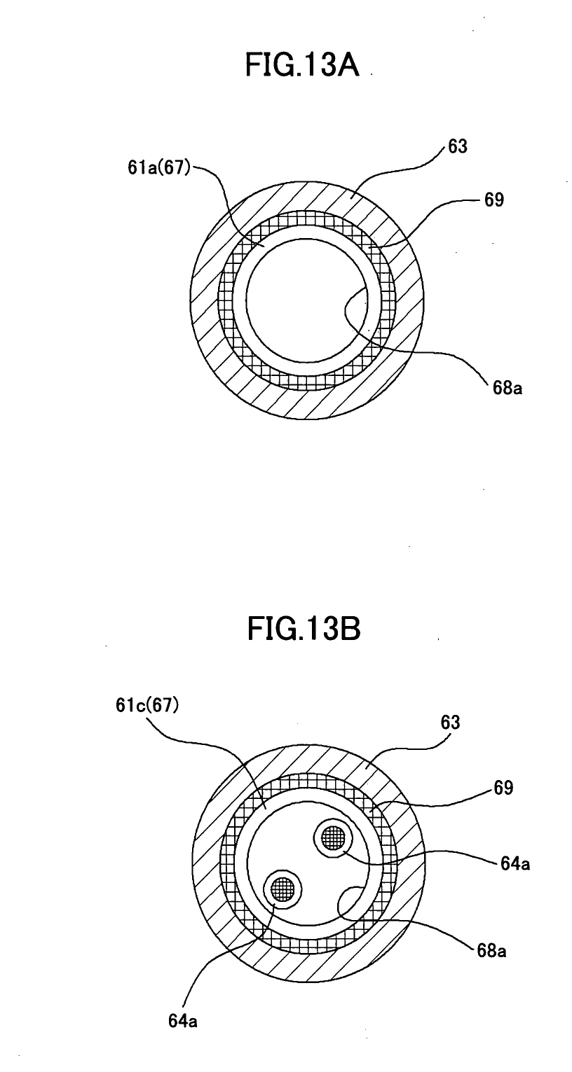

In the complex pipes 60, 60A of the above-mentioned structures, at least the pipe member for liquid preferably has an insulating structure. That is, referring to the complex pipe 60A, it is preferable to form an insulating layer 69 between the pipe members 61a, 61b, 61c and a cover member 63 covering the entire circumference of the pipe members 61a, 61b, 61c, the insulating layer 69 being made of, for example, a urethane rubber or a urethane resin material having flexibility and heat resistance (refer to FIG. 13A and FIG. 13B). By forming the insulating layer 69 between the pipe members 61a, 61b, 61c and the cover member 63, the chemical liquids flowing in the pipe members 61a, 61b, 61c and the liquid supply pipes 64A are prevented from being influenced by an outside ambient temperature.

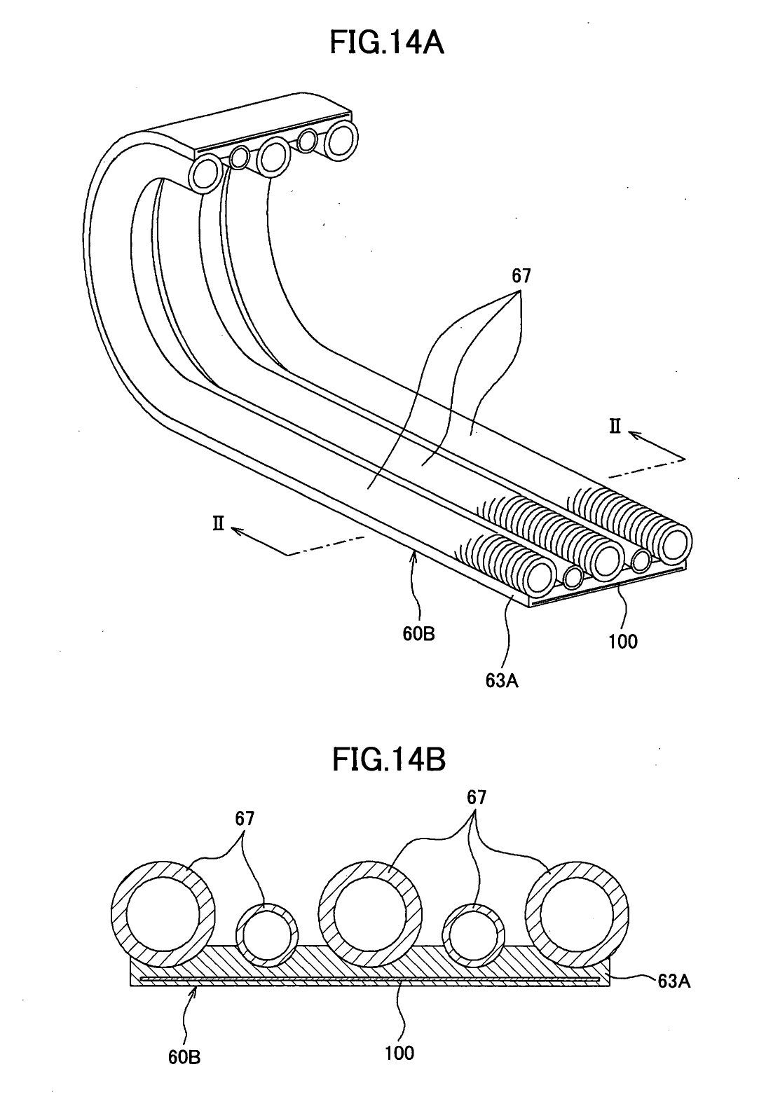

Although the description has been given of the case where the cable bear 90 is attached to the folded parts of the complex pipes 60, 60A in the above-mentioned embodiments so as to suppress vibration and bulging of the complex pipes 60, 60A during movement of the pipes, it is possible to suppress vibration and bulging of the complex pipes 60, 60A without attaching the cable bear 90. For example, as shown in FIG. 14A and FIG. 14B, quaking and bulging due to vibration of the folded part can be suppressed by forming a complex pipe 60B, which is formed by embedding a plate spring member 100 in a cover member 63A along an arranging direction of the pipe members 67 (bellows-like pipe members), the cover member 63A integrally connects lower parts of a plurality of pipe members, that are, lower end sides of the bellows-like pipe members 67.

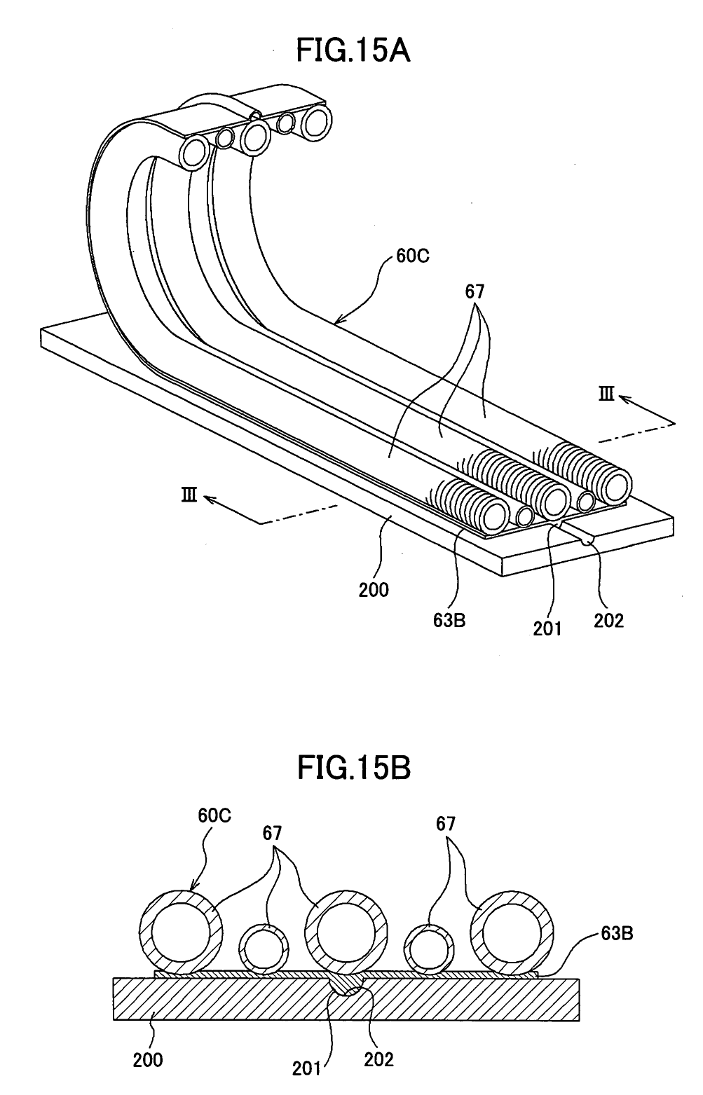

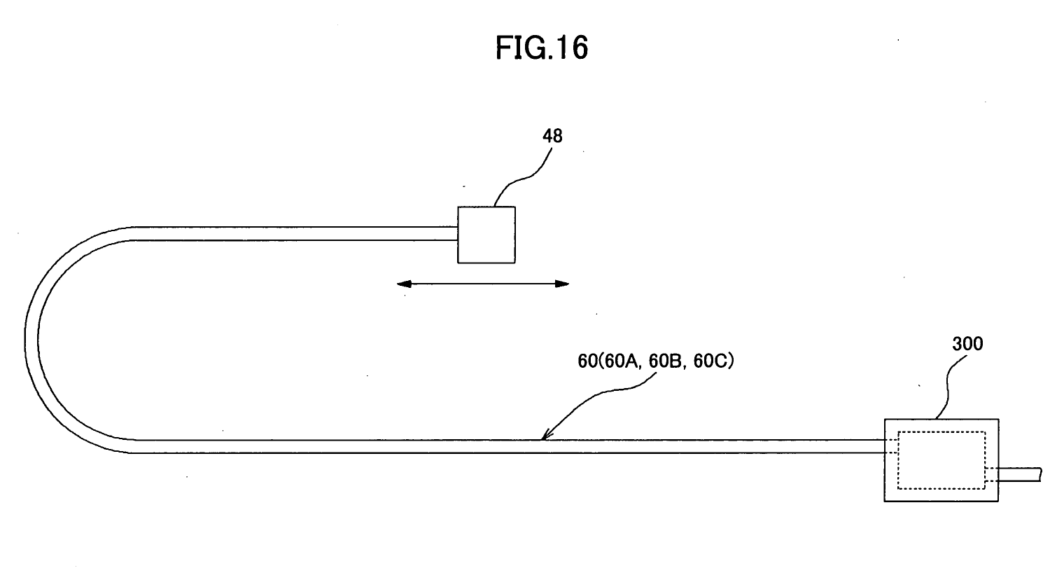

Additionally, as shown in FIGS. 15A and 15B, a base member 200 on which a cover member 63B is placed movably, the cover member 63B integrally combines the lower end sides of a plurality of bellow-like pipe members 67. A convex line 201 is provided in the central part of the contact surface of the cover member 63B which faces the base member 200 along a longitudinal direction of the pipe members 67 (bellows-like pipe members). A concave line 202 is provided in the central part of the contact surface of the base member 200 along the longitudinal direction so as to be slidably engaged with the convex line 201. Thereby, quaking of the complex pipe 60C in left and right directions can be suppressed, and a smooth movement can be achieved.

It should be noted that the convex line 201 and the concave line 202 may be provided reversely. That is, the concave line 202 may be provided to the contact surface of the cover member 63B and the convex member 201 may be provided to the contact surface of the base member 200.

Although the description was given, with reference to FIGS. 14A and 14B and FIGS. 15A and 15B, of the case where the cover members 63A, 63B cover a part of the pipe members, the cover members 63A, 63B may cover an entire circumference of the pipe members. In this case, if the pipe members are at least pipe members for liquid, an insulating layer having flexibility may be formed between the pipe members and the cover member.

Moreover, in the above-mentioned complex pipes 60, 60A, a buffer part 300 is connected to ends of the pipe members 61, 61a, 61b, 61c, which ends are connected to the stationary equipment side. The buffer part 300 serves as a volume enlargement part which enlarges a volume of each passage through which the liquid of each pipe member 61, 61a, 61b, 61c flows. By connecting the buffer part 300 to the pipe members 61, 61a, 61b, 61c, the liquids flowing through the pipe members 61, 61a, 61b, 61c are prevented from generating pulsation due to volume changes caused by changes in the lengths of the pipe members during movement of the pipes. Thereby, supply of the resist liquid, the development liquid and the rinse liquid can be stabilized.

Next, a description will be given of a process procedure of the wafer W in the resist coating/development processing apparatus having the above-mentioned structure.

<Process without Reflection-Preventing Film>

First, the carrier 20 is carried into the placement table 21 from outside, and the wafer W is taken out from the inside the carrier 20 by the transfer arm C. After the wafer W is conveyed by the transfer arm C to the transfer stage TRS1 of the shelf unit U5, the wafer W is conveyed by the delivery arm D to the cooling plate CPL3 of the third accommodation block 10c of the shelf unit U5. The wafer W is transferred to the main arm A4 of the COT layer B4 through the cooling plate CPL3. Then, the wafer W is conveyed by the main arm 4 to the hydrophobic process unit (ADH) and is subjected to a hydrophobic process. Thereafter, the wafer W is again transferred to the cooling plate CPL4 of the third accommodation block 10c of the shelf unit U5, and is adjusted to a predetermined temperature. Next, the wafer W taken out of the shelf unit U5 by the main arm A4 is conveyed to the coating unit 32, and a resist film is formed on the wafer W in the coating unit 32. The wafer W on which the resist film is formed is conveyed by the main arm A4 to the heating unit (CLHP4), and a prebake is applied to the wafer W so as to evaporate solvent from the resist film. Thereafter, the wafer W is accommodated by the main arm A4 in the placement shelf BUF2 of the third accommodation block 10c of the shelf unit U5, and stands by temporarily. Thereafter, the transfer arm D enters the placement shelf BUF2 of the third accommodation block 10c of the shelf unit U5 and receives the wafer W, and transfer the wafer W to the transfer stage TRS2 of the shelf unit U5. Subsequently, the wafer W is transferred by the shuttle arm A to the transfer stage ICPL of the shelf unit U6. Then, the wafer W on the transfer stage ICPL is conveyed by the interface arm E to the exposure apparatus S4, and a predetermined exposure process is carried out.

The wafer W after the exposure process is conveyed by the interface arm E to the transfer stage TRS3 of the shelf unit U6 so as to transfer the wafer W to the DEV layer B1 (or the DEV layer B2). The wafer W on the transfer stage TRS3 is received by the main arm A1 of the DEV layer B1 (or the DEV layer B2). First, the wafer W is subjected to a heating process by the heating unit (PEB1) in the DEV layer B1 (DEV layer B2), and, thereafter, the wafer W is conveyed by the main arm A1 to the cooling plate CPL7 (CPL8) of the shelf unit U6a and is adjusted to a predetermined temperature. Subsequently, the wafer W is taken out of the shelf unit U6 by the main arm A1 and conveyed to the development unit 31 and a development liquid is applied to the wafer W. Then, the wafer W is conveyed by the main arm A1 to the heating unit (POST1) and a predetermined development process is carried out. The thus-developed wafer W is conveyed to the cooling plate CPL9 (CPL10) of the first accommodation block 10a of the shelf unit U5 and is adjusted to a predetermined temperature so as to transfer the wafer W to the transfer arm C. Thereafter, the wafer W is returned by the transfer arm C to the original carrier 20 placed on the carrier block S1.

<Process of Forming a Reflection-Preventing Film Under a Resist Film>

First, the carrier 20 is carried into the placement table 21 from outside, and the wafer W is taken out of the carrier 20 by the transfer arm C. After the wafer W is transferred from the transfer arm C to the transfer arm D, the wafer W is conveyed by the transfer arm D to the cooling plate CPL1 of the second accommodation block 10b of the shelf unit U5, and the wafer W is transferred to the main arm A3 of the BCT layer B3 through the cooling plate CPL1.

Then, in the BCT layer B3, the wafer W is conveyed by the main arm A3 to the first reflection-preventing film formation unit 33→the heating unit (CLHP)→the placement shelf BUF1 of the second accommodation block 10b of the shelf unit U5, in that order, and, thereby, the first reflection-preventing film is formed. The wafer W placed on the placement shelf BUF1 in the second accommodation block 10b is conveyed by the transfer arm D to the cooling plate CPL3 (CPL4) of the third accommodation block 10c, and a temperature adjustment is carried out to a predetermined temperature.

Subsequently, the wafer W of the third accommodation block 10c is conveyed by the main arm A4 to the coating unit 32→the heating unit CLHP4→the placement shelf BUF2 of the third accommodation block 10c of the shelf unit U5, in that order, and, thereby, a resist film is formed on the first reflection-preventing film.

Thereafter, the transfer arm D enters the placement shelf BUF2 of the third accommodation block 10c of the shelf unit U5 and receives the wafer W, and transfers the wafer W to the transfer stage TRS2 of the shelf unit U5. Subsequently, the wafer W is transferred by the shuttle arm A to the transfer stage ICPL of the shelf unit U6. Then, the wafer W on the transfer stage ICPL is conveyed by the interface arm E to the exposure apparatus S4, and a predetermined exposure process is carried out.

The wafer W after the exposure process is conveyed by the interface arm E to the transfer stage TRS3 of the shelf unit U6, and is conveyed by the main arm A1 to the heating unit (PEB1)→the cooling plate CPL7 (CPL8) of the shelf unit U6→the development unit 31→the heating unit (POST1), in that order, and a predetermined development process is carried out. The thus-developed wafer W is conveyed to the cooling plate CPL9 (CPL10) of the first accommodation block 10a of the shelf unit U5 and is adjusted to a predetermined temperature so as to transfer the wafer W to the transfer arm C. Thereafter, the wafer W is returned by the transfer arm C to the original carrier 20 placed on the carrier block S1.

<Process of Forming a Reflection-Preventing Film on a Resist Film>

First, the carrier 20 is carried into the placement table 21 from outside, and the wafer W is taken out of the carrier 20 by the transfer arm C. After the wafer W is transferred by the transfer arm C to the transfer stage TRS1 of the shelf unit U5, the wafer W is conveyed by the transfer arm D to the cooling plate CPL3 of the third accommodation block 10c of the shelf unit U5, and the wafer W is transferred to the main arm A4 of the COT layer B4 through the cooling plate CPL3. Then, the wafer W is conveyed by the main arm A4 to the hydrophobic process unit (ADH)→the cooling plate CPL4 of the third accommodation block 10c of the shelf unit U5, in that order, thereby, the wafer W is adjusted to a predetermine temperature. Then, the wafer taken out of the shelf unit U5 by the main arm A4 is conveyed to the coating unit 32, and a resist film is formed in the coating unit 32. The wafer W on which the resist film is formed is conveyed by the main arm A4 to the heating unit (CLHP4), and a prebake is applied to the wafer W so as to evaporate solvent from the resist film. Thereafter, the wafer W is accommodated by the main arm A4 in the placement shelf BUF2 of the third accommodation block 10c of the shelf unit U5, and stands by temporarily.

Thereafter, the wafer W of the third accommodation block 10c is conveyed by the transfer arm D to the cooling plate CPL5 (CPL6) of the fourth accommodation block 10d of the shelf unit U5, and is temperature-adjusted to a predetermined temperature, and, thereafter, the wafer W is transferred to the main arm A5 of the TCT layer B5 through the cooling plate CPL5 (CPL6). Then, in the TCT layer B5, the wafer W is conveyed by the main arm A5 to the second reflection-preventing film formation unit 34→the heating unit (CLPH5)→the placement shelf BUF3 of the fourth accommodation block 10c of the shelf unit U5, in that order, and, thereby, the second reflection-preventing film is formed. It should be noted that, in this case, the wafer W may be conveyed to the placement shelf BUF3 of the fourth accommodation block 10c of the shelf unit U5, after conveying the wafer W to the peripheral exposure equipment (WEE) and applying a peripheral exposure process after the heating process by the heating unit (CHP5).

Thereafter, the transfer arm D enters the placement shelf BUF3 of the fourth accommodation block 10d of the shelf unit U5 and receives the wafer W, and transfers the wafer W to the transfer stage TRS2 of the shelf unit U5. Subsequently, the wafer W is transferred by the shuttle arm A to the transfer stage ICPL of the shelf unit U6. Then, the wafer W on the transfer stage ICPL is conveyed by the interface arm E to the exposure apparatus S4, and a predetermined exposure process is carried out.

The wafer W after the exposure process is conveyed by the interface arm E to the transfer stage TRS3 of the shelf unit U6, and is conveyed by the main arm A1 to the heating unit (PEB1)→the cooling plate CPL7 (CPL8) of the shelf unit U6→the development unit 31→the heating unit (POST1), in that order, and a predetermined development process is carried out. The thus-developed wafer W is conveyed to the cooling plate CPL9 (CPL10) of the first accommodation block 10a of the shelf unit U5 and is adjusted to a predetermined temperature so as to transfer the wafer W to the transfer arm C. Thereafter, the wafer W is returned by the transfer arm C to the original carrier 20 placed on the carrier block S1.

<Process of Forming Reflection-Preventing Films Under and on a Resist Film>

When forming the reflection-preventing film on a lower side and an upper side of the resist film, the above-mentioned process of forming a reflection-preventing film on a resist film and the above-mentioned process of forming a reflection-preventing film under a resist film are combined so as to form the reflection-preventing films on a lower side and an upper side of the resist film. That is, first, the carrier 20 is carried into the placement table 21 from outside, and the wafer W is taken out of the carrier 20 by the transfer arm C and is transferred to the transfer arm D. Thereafter, the wafer W is conveyed by the transfer arm D to the cooling plate CPL1 of the second accommodation block 10b of the shelf unit U5, and the wafer W is transferred to the main arm A3 of the BCT layer B3 through the cooling plate CPL1.

Then, in the BCT layer B3, the wafer W is conveyed by the main arm A3 to the first reflection-preventing film formation unit 33→the heating unit (CLHP)→the placement shelf BUF1 of the second accommodation block 10b of the shelf unit U5, in that order, and, thereby, the first reflection-preventing film is formed. The wafer W placed on the placement shelf BUF1 in the second accommodation block 10b is conveyed by the transfer arm D to the cooling plate CPL3 (CPL4) of the third accommodation block 10c, and a temperature adjustment is carried out to a predetermined temperature.

Subsequently, the wafer W of the third accommodation block 10c is conveyed by the main arm A4 to the coating unit 32→the heating unit CLHP4→the placement shelf BUF2 of the third accommodation block 10c of the shelf unit U5, in that order, and, thereby, a resist film is formed on the first reflection-preventing film.

Subsequently, the wafer W of the third accommodation block 10c is conveyed by the transfer arm D to the cooling plate CPL5 (CPL6) of the fourth accommodation block 10d of the shelf unit U5, and is temperature-adjusted to a predetermined temperature, and, thereafter, the wafer W is transferred to the main arm A5 of the TCT layer B5 through the cooling plate CPL5 (CPL6). Then, in the TCT layer B5, the wafer W is conveyed by the main arm A5 to the second reflection-preventing film formation unit 34→the heating unit (CLPH5)→the placement shelf BUF3 of the fourth accommodation block 10c of the shelf unit U5, in that order, and, thereby, the second reflection-preventing film is formed on the resist layer. It should be noted that, in this case, the wafer W may be conveyed to the placement shelf BUF3 of the fourth accommodation block 10c of the shelf unit U5, after conveying the wafer W to the peripheral exposure equipment (WEE) and applying a peripheral exposure process after the heating process by the heating unit (CHP5).

Thereafter, the transfer arm D enters the placement shelf BUF3 of the fourth accommodation block 10d of the shelf unit U5 and receives the wafer W, and transfers the wafer W to the transfer stage TRS2 of the shelf unit U5. Subsequently, the wafer W is transferred by the shuttle arm A to the transfer stage ICPL of the shelf unit U6. Then, the wafer W on the transfer stage ICPL is conveyed by the interface arm E to the exposure apparatus S4, and a predetermined exposure process is carried out.

The wafer W after the exposure process is conveyed by the interface arm E to the transfer stage TRS3 of the shelf unit U6, and is conveyed by the main arm A1 to the heating unit (PEB1)→the cooling plate CPL7 (CPL8) of the shelf unit U6→the development unit 31→the heating unit (POST1), in that order, and a predetermined development process is carried out. The thus-developed wafer W is conveyed to the cooling plate CPL9 (CPL10) of the first accommodation block 10a of the shelf unit U5 and is adjusted to a predetermined temperature so as to transfer the wafer W to the transfer arm C. Thereafter, the wafer W is returned by the transfer arm C to the original carrier 20 placed on the carrier block S1.

The above-mentioned coating/development processing apparatus is equipped with a control part 70 constituted by a computer, which performs management of a recipe of each process unit, schedule management of a conveyance flow (conveyance path) of the wafer W, a process in each process unit, and a drive control of the main arms A1, A3 to A5, the shuttle arm A, the transfer arm C, the transfer arm D and the interface arm E. The control part 70 uses the unit blocks B1 to B5 to convey the wafer W so that a predetermined process is performed on the wafer W.

The schedule of the above-mentioned conveyance flow designates the conveyance path (order of conveyance) of the wafer W in the unit block, and is created according to a kind of the coating film to be formed for each of the unit blocks B1 to B5, and, thereby, a plurality of schedules of the conveyance flow are stored for each of the unit blocks B1 to B5.

Moreover, an appropriate mode can be set from a mode of conveying the wafer W to all of the unit blocks B1 to B5, a mode of conveying the wafer W to the unit block (the DEV layers B1, B2) performing a development process, the unit block (the COT layer B4) performing a coating of a resist, and the unit block (the BCT layer B3) forming the first reflection-preventing film, a mode of conveying the wafer W to the unit block (the DEV layers B1, B2) performing a development process, the unit block (the COT layer B4) performing a coating of a resist, and the unit block (the TCT layer B5) forming the second reflection-preventing film, and a mode of conveying the wafer W to only the unit block (the DEV layers B1, B2) performing a development process. By selecting an appropriate mode by a mode selecting means of the control part 70, a unit block for conveying the wafer W is selected in accordance with a kind of a coating film to be formed, and by selecting an appropriate recipe from the plurality of schedules of conveyance flow prepared for each unit block selected, the unit block to use is selected in accordance with the coating film to be formed. In the unit block, each process unit and drive of the arms are controlled, and a series of processes are performed.

In the above-mentioned coating/development processing apparatus, since the unit block for forming each coating film and the unit block for a development process are located in different areas and the exclusive main arms A1, A3 to A5 and the shuttle arm A are provided in each area, a load to the arm A1, A3 to A5 and the shuttle arm A is reduced. Thus, the conveyance efficiency of the arms A1, A3 to A5 and the shuttle arm A is improved, which provides the effect of raising a throughput.

The present invention is not limited to the specifically disclosed embodiments, and variations and modifications may be made without departing from the scope of the present invention.

The present application is based on Japanese priority application No. 2006-282147 filed Oct. 17, 2006, the entire contents of which are hereby incorporated herein by reference.

What is claimed is:

1. A complex pipe having a plurality of pipe members containing at least a pipe member for liquid and a pipe member for electricity being fixed in parallel arrangement, one end thereof connected to a stationary equipment and the other end connected to a movable member,
wherein said plurality of pipe members are integrally combined by a cover member having flexibility, a liquid supply pipe being inserted with a space in said pipe member for liquid, and a fluid for temperature adjustment is supplied to said space between said pipe member for liquid and said liquid supply pipe.

2. The complex pipe as claimed in claim 1, wherein said pipe members are bellows pipe members having flexibility.

3. The complex pipe as claimed in claim 2, wherein an electric wire is inserted into said pipe member for electricity with a space therebetween, and the space between said pipe member for electricity and said electric wire forms an exhaust passage connected to an exhaust apparatus.

4. The complex pipe as claimed in claim 2, wherein a thermal insulation layer is formed at least between said pipe member for liquid and the cover member covering an entire circumference of said pipe member for liquid.

5. The complex pipe as claimed in claim 2, wherein a plate spring member is provided along an arranging direction of the pipe members in said cover member.

6. The complex pipe as claimed in claim 2, wherein a base member on which said cover member is movably placed is provided, and a concave line and a convex line engaging with each other are formed on opposing contact surfaces of the base member and said cover member.

7. The complex pipe as claimed in claim 2, wherein a volume enlargement part of a liquid flowing in the pipe members is provided to an end part of said pipe member for liquid.

8. The complex pipe as claimed in claim 1, wherein an electric wire is inserted into said pipe member for electricity with a space therebetween, and the space between said pipe member for electricity and said electric wire forms an exhaust passage connected to an exhaust apparatus.

9. The complex pipe as claimed in claim 1, wherein a thermal insulation layer is formed at least between said pipe member for liquid and the cover member covering an entire circumference of said pipe member for liquid.

10. The complex pipe as claimed in claim 1, wherein a plate spring member is provided along an arranging direction of the pipe members in said cover member.

11. The complex pipe as claimed in claim 1, wherein a base member on which said cover member is movably placed is provided, and a concave line and a convex line engaging with each other are formed on opposing contact surfaces of the base member and said cover member.

12. The complex pipe as claimed in claim 1, wherein a volume enlargement part of a liquid flowing in the pipe members is provided to an end part of said pipe member for liquid.

13. A coating/development processing apparatus comprising:
a complex pipe as claimed in claim 1;
a coating process part that applies a process by supplying a coating liquid to a substrate to be processed; and
a development process part that applies a process by supplying a developer liquid to said substrate to be processed,
wherein said coating process part and said development process part are equipped with a liquid supply nozzle and a moving mechanism of the liquid supply nozzle, and
said movable member of said complex pipe is connected to said liquid supply nozzle and said moving mechanism.

14. The coating/development processing apparatus as claimed in claim 13, wherein said pipe members are bellows pipe members having flexibility.

15. The coating/development processing apparatus as claimed in claim 14, wherein an electric wire is inserted into said pipe member for electricity with a space therebetween, and the space between said pipe member for electricity and said electric wire forms an exhaust passage connected to an exhaust apparatus.

16. The coating/development processing apparatus as claimed in claim 14, wherein a thermal insulation layer is formed at least between said pipe member for liquid and the cover member covering an entire circumference of said pipe member for liquid.

17. The coating/development processing apparatus as claimed in claim 14, wherein a plate spring member is provided along an arranging direction of the pipe members in said cover member.

18. The coating/development processing apparatus as claimed in claim 14, wherein a base member on which said cover member is movably placed is provided, and a concave line and a convex line engaging with each other are formed on opposing contact surfaces of the base member and said cover member.

19. The coating/development processing apparatus as claimed in claim 14, wherein a volume enlargement part of a liquid flowing in the pipe members is provided to an end part of said pipe member for liquid.
